(19) United States
(12) Patent Application Publication
(10) Pub. No.: US 2013/0307854 A1
(43) Pub. Date: Nov. 21, 2013

(54) Method and System for Visualising a System Model

(71) Applicants: Broy Hannah Karin Nora, Munchen (DE); Eckl Roland, Munchen (DE); Femmer Henning, Coesfeld (DE); Macwilliams Asa, Furstenfeldbruck (DE); Zec Marin, Isny (DE)

(72) Inventors: Broy Hannah Karin Nora, Munchen (DE); Eckl Roland, Munchen (DE); Femmer Henning, Coesfeld (DE); Macwilliams Asa, Furstenfeldbruck (DE); Zec Marin, Isny (DE)

(21) Appl. No.: 13/883,434

(22) PCT Filed: Oct. 4, 2011
(86) PCT No.: PCT/EP11/67251

§ 371 Date: May 3, 2013

(30) Foreign Application Priority Data
Nov. 8, 2010 (DE) 10 2010 043 550.3

(51) Int. Cl. G06T 11/20

(52) U.S. Cl. CPC G06T 11/206
USPC 345/440

(57) ABSTRACT

A method for visualising a system model of a target system may include the steps of detecting a plurality of events which take place in the target system, extracting entity instances involved in the detected events in the target system and associating the extracted entity instances with entity types of an entity model of the target system, extracting entity relations of the entity instances involved in the detected events, and generating an entity graph by geometrically arranging representative objects for the entity instances according to the entity relations dependent on predetermined selection criteria for the entity types to be indicated by the entity graph.

### CROSS-REFERENCE TO RELATED APPLICATIONS

This application is a U.S. National Stage Application of International Application No. PCT/EP2011/067251 filed Oct. 4, 2011, which designates the United States of America, and claims priority to DE Patent Application No. 10 2010 043 550.3 filed Nov. 8, 2010 The contents of which are hereby incorporated by reference in their entirety.

### TECHNICAL FIELD

The present disclosure pertains to a method and a system for visualising of a system model, particularly for visualisation of entities and event trails of distributed systems.

### BACKGROUND

In operation complex systems comprise thousands of different elements. For example, while operating a computer system hardware and software elements are related to each other by associated relations. There are complex relationships between these elements which may be referred to as entities, the relationships being subject to dynamic changes during the operation of the system.

For operators, developers or users of a system the complex relationships of such systems are hard to keep track of while developing, modifying or maintaining the system. To get an understanding of the technical context in such systems it takes a lot of time and profound knowledge of the underlying architecture of the system.

Particularly for distributed heterogeneous systems it is hard to get an overview over the chronological operation procedures. A localisation of errors or starting points for modifications of the system is often not possible.

Documentations of operating procedures of complex system are often written down statically. Due to the multitude of possible interrelationships such documentations are frequently incomplete or obsolete. Additionally, static documentations of large systems with a lot of different elements are in many cases confusing by itself and difficult to get an overview of for a user. Other possibilities for visualisation of complex systems like logging, tracing or profiling tools are usually specifically adapted to the system.

### SUMMARY

One embodiment provides a method for visualising a system model of a target system, comprising the steps of: detecting a plurality of events which take place in the target system; extracting entity instances involved in the detected events in the target system and associating the extracted entity instances with entity types of an entity model of the target system; extracting entity relations of the entity instances involved in the detected events; and generating an entity graph by geometrically arranging representative objects for the entity instances according to the entity relations dependent on predetermined selection criteria for the entity types to be indicated by the entity graph.

In a further embodiment, the method further comprises the steps of: detecting a further event taking place in the target system; extracting entity instances involved in the further event and further entity relations; and updating the entity graph by including further representative objects for the further entity instances or deleting representative objects, and changing the representative objects or the geometrical arrangement of the representative objects on the basis of the further entity relations.

In a further embodiment, the method further comprises the step of generating an event graph by geometrically arranging representative objects for the detected dependent on the chronological order of the detected events.

In a further embodiment, the method further comprises the step of illustrating the entity graph on an illustration device during the detecting of further events.

In a further embodiment, the method further comprises the steps of updating the selection criteria; and updating the entity graph on the basis of the updated selection criteria.

In a further embodiment, the selection criteria comprise a frequency of occurrence of the entity instances, an ending point of the detected events, a frequency of occurrence of the entity relations and/or the type of entity of the entity instances.

In a further embodiment, the geometrical arrangement comprises a tree structure, a nested object structure, a concentric sector structure and/or a UML diagram structure.

Another embodiment provides a system for visualising a system model of a target system, the system comprising: a detection interface configured to receive data of a plurality of events taking place in the target system; an extraction device configured to extract entity instances of the target system involved in the events from the received data and to associate the entity instances to entity types of an entity model of the target system and configured to extract entity relations of the entity instances involved in the events from the received data; a generating device configured to generate an entity graph by geometrically arranging representative objects for the entity instances depending on the entity relations on the basis of predetermined selection criteria for the entity types to be indicated by the entity graph; and an illustration device configured to graphically illustrate the generated entity graph.

In a further embodiment, the system is configured to receive data of further events which take place in the target system in real time, wherein the extraction device is configured to extract further entity instances involved in the further events and further entity relations from the further data, wherein the generating device is configured to update the entity graph by incorporating further representative objects for the further entity instances or deleting representative objects, and changing the representative objects or the geometrical arrangement of the representative objects on the basis of the further entity relations, and wherein the illustration device is configured to update the graphical illustration of the entity graph in real time.

In a further embodiment, the generating device is further configured to generate an entity graph by geometrically arranging representative objects for the events dependent on the chronological order of the events.

In a further embodiment, the detection interface is configured to receive data of events taking place on a plurality of independent interacting system components of a distributed system, and the extraction device is further configured to extract entity relations between entity instances of different system components from the data.

In a further embodiment, the selection criteria comprise a frequency of occurrence of the entity instances, an ending point of the detected events, a frequency of occurrence of the entity relations and/or the type of entity of the entity instances.

In a further embodiment, the geometrical arrangement comprises a tree structure, a nested object structure, a concentric sector structure and/or a UML diagram structure.

Another embodiment provides a distributed system, comprising: a plurality of independent interacting system components which each comprise one or more entities and on which events involving the entities take place; at least one detection device which is configured to detect data of events taking place on the system components; and a system as disclosed herein for visualising a system model of the distributed system, wherein the system is configured to receive the data detected by the detection device and to illustrate an entity graph of the entities of the plurality of system components.

### BRIEF DESCRIPTION OF THE DRAWINGS

Exemplary embodiments will be explained in more detail below based on the schematic drawings, wherein:

FIG. 1 shows a schematic illustration of a system environment according to an example embodiment;

FIG. 2 shows a schematic illustration of a system model according to a further example embodiment;

FIG. 3 shows a schematic illustration of an exemplary entity type model of a system model according to a further example embodiment;

FIG. 4a shows a schematic illustration of an exemplary entity graph according to a further example embodiment;

FIG. 4b shows a schematic illustration of an exemplary event graph according to a further example embodiment;

FIG. 4c shows a schematic illustration of an exemplary event graph according to a further example embodiment;

FIG. 5 shows a schematic illustration of a system for visualising a system model of a target system according to a further example embodiment; and

FIG. 6 shows a schematic illustration of a method for visualising a system model of a target system according to a further example embodiment.

### DETAILED DESCRIPTION

Some embodiments provides a method for visualising a system model of a target system, the method comprising the steps of detecting a plurality of events which take place in the target system, extracting entity instances involved in the detected events in the target system and associating the extracted entity instances with entity types of an entity model of the target system, extracting entity relations of the entity instances involved in the detected events, and generating an entity graph by geometrically arranging representative objects for the entity instances according to the entity relations dependent on predetermined selection criteria for the entity types to be indicated by the entity graph.

This method graphically illustrates relationships between elements or entities, respectively, of a target system automatically. Thus, specific knowledge of the target system may not be needed since the method determines entity instances and their entity relations by automatic event analysis.

Moreover, the method may provide the possibility to dynamically and flexibly generate graphs on the basis of predetermined and adjustable selection criteria. This allows for the adaptation of the scalability, the complexity and the lucidity of the generated graphs to the visualisation.

This may be useful, e.g., for large target system having a lot of entity instances and a lot of events possibly happening within a short timeframe since the generation of a geometrical arrangement with representative objects may reduce the complexity of a generated graph substantially and may allow for a compact representation even in a limited representation area.

Detecting a further event taking place in the target system, extracting further entity instances and further entity relations involved in the further event, and updating the entity graph by including of further representative objects for the further entity instances or deleting of representative objects, and changing the representative objects or of the geometrical arrangement of the representative objects on the basis of the further entity relations may be performed. This allows for a representation of graphs in real time which reacts on newly happening events and indicates the development of the dependencies of the entity instances of the target system in a clear and efficient way.

In a method generating an event graph by geometrically arranging representative objects for the detected events may be performed on the basis of the chronological order of the detected events. This allows for a compact, scalable and clear representation of a plurality of events as graph, even on a limited illustration area. Moreover, it is possible to illustrate chronological and causal relationships between single ones of the plurality of events.

In one embodiment the method may be performed dynamically and in real time by illustrating the entity graph on an illustration device during the detection of further events and by updating the graph depending on the detection of the further events.

The selection criteria which may include a frequency of occurrence of the entity instances, an ending point of the detected events, a frequency of occurrence of the entity relations and/or the type of entity of the entity instances may be adapted flexibly to perform an updating of the entity graph on the basis of the adjusted selection criteria.

Other embodiments provide a system for visualising a system model of a target system, the system comprising a detection interface configured to receive data of a plurality of events taking place in the target system, an extraction device configured to extract entity instances of the target system involved in the events from the received data and to associate the entity instances to entity types of an entity model of the target system and configured to extract entity relations of the entity instances involved in the events from the received data, a generating device configured to generate an entity graph by geometrically arranging representative objects for the entity instances depending on the entity relations on the basis of predetermined selection criteria for the entity types to be indicated by the entity graph, and an illustration device configured to graphically illustrate the generated entity graph.

The detection interface may be configured to receive data of events taking place on a plurality of independent interacting system components of a distributed system and the extraction device may be further configured to extract entity relations between entity instances of different ones of the system components from the data. This may allow data for events in different distributed system components to be collected and bundled up in a central system, in order to generate entity and/or event graphs encompassing different components. This allows for a compact, clear and dynamic total overview over a distributed system.

Still other embodiments provide a distributed system having a plurality of independent interacting system components which each comprise one or more entities and on which events involving the entities take place, at least one detection device which is configured to detect data of events taking place on the system components, and a system for visualising a system model of the distributed system, wherein the system is configured to receive the data detected by the detection device and to illustrate an entity graph of the entities of the plurality of system components.

Entities within the meaning of the present disclosure may comprise all technical or logical constitutive elements of a target system, its source code or its environment. For example, entities may be processors, computers, storage areas, objects, database entries, files, processes, threads, network addresses, ports, user names, rooms in a building, work pieces in an automation system, machine components or other similar elements. Each entity may be associated with an entity type. Entities may in general refer to a technical or logical element while a specific technical or logical element of a specific target system or one of its system components may be referred to as entity instances, i.e. as specific embodiment of an entity.

Events within the meaning of the present disclosure may comprise all procedural technical or logical sequences in a target system. Events may comprise a time stamp and entities or entity instances constitutively involved in the course of the event. The time stamp may comprise a point in time at which the event has started or ended or a time span during which the event has taken place.

Target systems within the meaning of the present disclosure may comprise all systems having a multitude of interacting elements or entities, respectively. For example, target systems may be automation facilities, computer systems, client server systems, operating systems, manufacturing facilities, machines, robots, processors or similar systems. In particular, target systems within the meaning of the present disclosure may comprise distributed systems, i.e. systems having a number of independent and interacting system components each including separate sets of entity instances which may be related to entity instances of other system components during the course of events. Distributed systems may for example comprise multicore processor systems, manufacturing facilities having different manufacturing stations, computer cluster, networked computer structures (computer grids) or similar systems.

Graphs within the meaning of the present disclosure may refer to all structured visual forms of illustration which may be constructed by positioning of graphical objects relatively to each other in one or more dimensions. Graphs may thus include tree diagrams, box diagrams in embedded or stacked form, sector diagrams, bar diagrams, line diagrams, histograms, point diagrams, bubble diagrams, Gantt diagrams, Sankey diagrams, dendrograms or similar forms of visualised information.

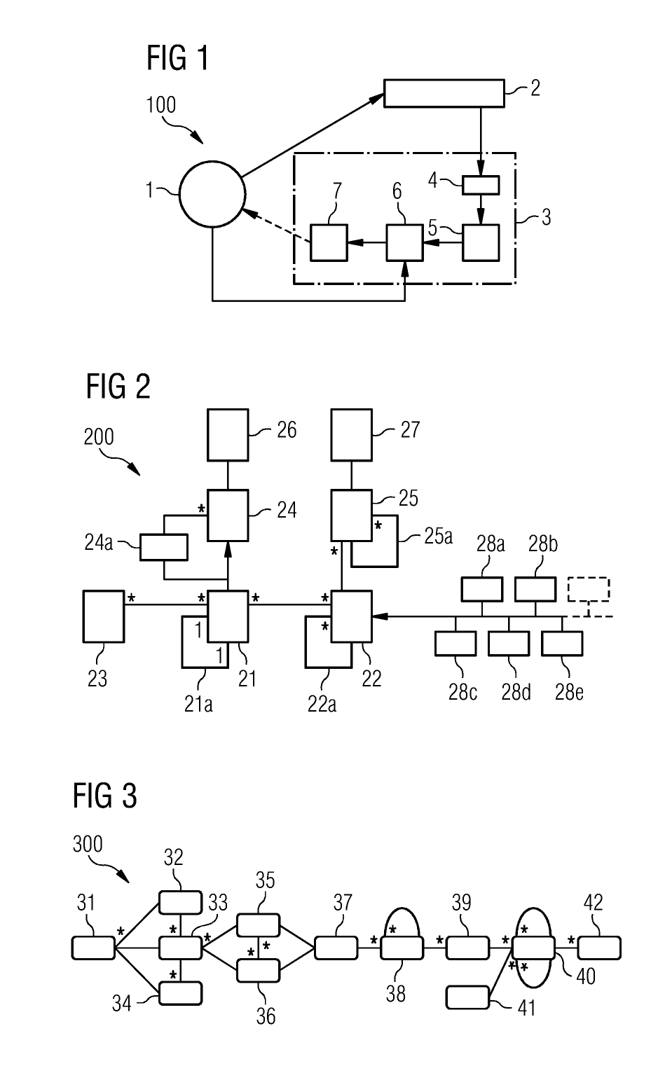

FIG. 1 shows a schematic illustration of a system environment 100. A user or developer 1 of a target system 2 may utilize a system 3 for visualising a system model of the target system 2. The system 3 may be referred to a visualiser. The visualiser 3 detects via a detection interface 4 data of events which take place in the target system 2. The data detected in the detection interface 4 are forwarded to an extraction device 5 which extracts entity instances from the detected event data and associates them to entity types according to a data model. Furthermore, the extraction device 5 extracts entity relations between the entity instances from the event data.

The entity instances and the entity relations are inputted to a generating device 6 which generates entity and/or event graphs from the event data, the entity instances and the entity relations. The graphs may be generated according to predetermined or adjustable selection criteria. The graphs generated by the generating device 6 are inputted to an illustration device 7, for example the graphics engine of a computer, which illustrates the graphs for example on a computer screen for the user 1. The user 1 may change or adjust the selection criteria in the generating device 6 in order to adjust an adaptation of the illustration or the contents of the graphs for the illustration device 7. This may for example be effected in order to reduce the complexity of the graphs, to adapt the detailedness of the graphs or to adapt the speed of the graph updates.

FIG. 2 shows a schematic illustration of a system model 200 with dependencies of events and entities as UML class diagram. A flow of events 23 may for example include a plurality of events 21 which each comprise a time stamp indicating starting point, ending point and/or duration of the event 21. Moreover, different events 21 may be coupled with each other by means of an event reference 21a. For example, the affiliation of two associated events with an superordinate event or a commonly associated entity may be indicated by an event reference 21a. The events 21 may be grouped up in event clusters 24a. An event tree 26 may be comprised of event tree nodes 24 which are each associated with an event 21 or an event cluster 24a.

The events 21 themselves each include an amount of interacting entities 22 which may each be associated with one of a plurality of entity types 28a, . . . , 28e. The entities 22 may have a hierarchical structure 22a among themselves. Entities 22 of a specific target system or a specific target system component may be referred to as entity instances. An entity tree 26 may comprise entity tree nodes 25 which may be arranged according to a node hierarchy 25a. Each entity tree node 25 may be associated with an entity 22 or an entity instance 22, respectively.

FIG. 3 shows a schematic illustration of an exemplary entity type model 300 in a system model. According to the entity type model 300 entity trees 27 may for example automatically be constructed from detected event data of the target system. In the example of FIG. 3 an entity type model 300 is shown for a computer operating system. The entity type “user” 31 is related to the entity types host 32 and process 33 which themselves are interrelated. The entity type process 33 for example is related to the entity types thread 34, program 35 and library 36, wherein the entity types program 35 and library 36 may themselves be interrelated. The entity types program 35 and library 36 may comprise an entity relation with the entity type project 37 which itself is interrelated to the entity type folder 38. The entity type folder 38 may comprise an inherent hierarchical nesting and may have an entity relation to the entity type source code 39. The entity type source code 39 may have an entity relation with the entity type class 40. The entity type class 40 may have an inherent hierarchical nesting as well as an inheritance structure and may comprise an entity relation with the entity types function 42 and namespace/packet 41.

Entity trees 27 may be generated according to an entity type model, for example the exemplary model 300 shown in FIG. 3, from entity instances 22 and entity relations which are both extracted from event data. The entity trees 27 may start with a top root node as uppermost hierarchical level. Entity instances 22 extracted from event data are added to the entity tree 27. The entity tree 27 may be constructed such that the hierarchy levels following the root node may be incorporated into the entity tree 27 according to the entity type model. Thereby an entity tree 27 may be generated dynamically, i.e. for every new event the data of which is detected new entity instances 22 may be established which may be hierarchically included into an already existing entity tree 27 according to the entity type model. Already existing hierarchical structures within the entities 22 themselves may be utilized in that process. For example, folders in a file system are already hierarchically ordered so that this hierarchy may be incorporated into the entity tree 27 as subhierarchy.

It may be possible to extract entity relations from the event data and arrange them between the entity instances in the entity tree 27 for example as arrows and connecting lines. The arrows and connecting lines may for example illustrate a chronological sequence of events which refer to the associated entity instances 22. In that case an arrow pointing from an entity instance A to an entity instance B may indicate that following an event involving the entity instance A an event occurs which involves entity instance B. This may for example be useful in visualising program flows.

It may also be possible to establish a relationship between entity instances of different entity types. Hence, arrows may point from an entity instance A of an entity type X to an entity instance B of another entity type Y if both entity instances A and B are causally tied to each other within events. For example, this way of illustration may be useful when visualising accesses of processes to files.

Alternatively it is possible to illustrate other entity relations, for example communication connections between processes or threads, references between objects or inheritance relationships between classes. It should be obvious that a multitude of different entity relations may be visualised by corresponding geometrical symbols within an entity tree 27, whereby the selection of the entity relations to be visualized may be dependent on selection criteria given by a user.

The selection criteria may for example comprise a frequency of occurrence of the entity instances, an ending point of the detected events, a frequency of occurrence of the entity relations and/or the entity type of the entity instances. The selection criteria may for example be used to reduce the complexity of an entity tree 27 to be generated.

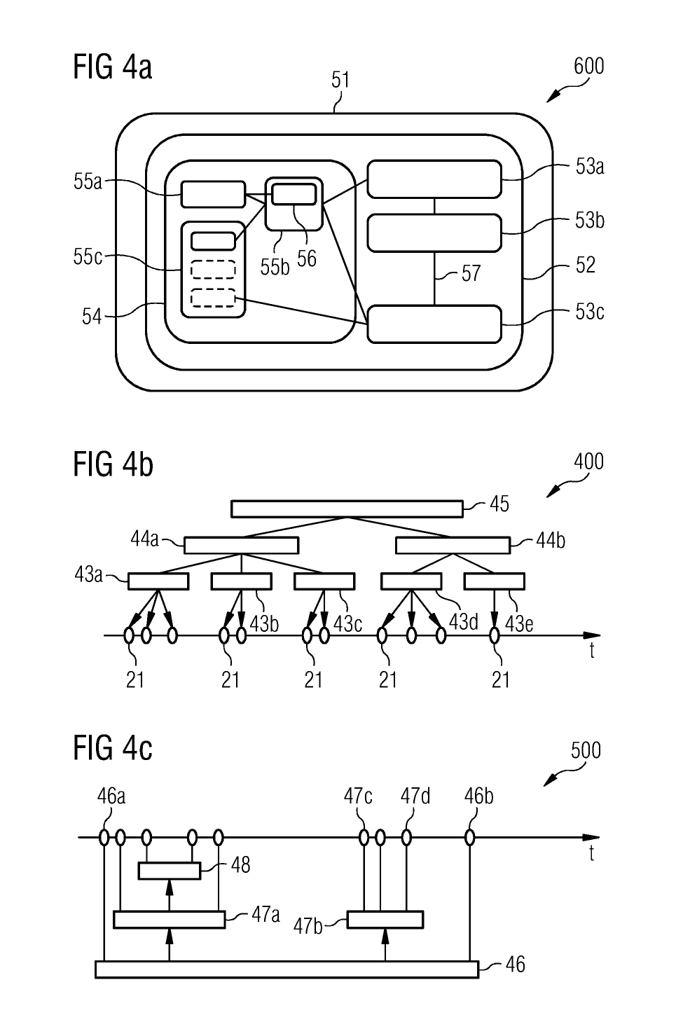

In FIG. 4a an exemplary entity graph 600 is shown which has been generated using entity instances and entity relations extracted from event data. In the exemplary embodiment of FIG. 4a the entity graph 600 has been generated in a nested box view. The entity instances are illustrated by representative objects in form of rectangles having rounded corners. The representative objects each indicate an associated entity instance. The representative objects may further be tagged by information relating to the entity instance represented by the respective object. For example, names, type identifiers, serial numbers or other typifying alphanumerical symbols may be arranged in a proximity to the representative objects graphically, the symbols indicating an association with the representative objects. It may also be possible to present hints about the character, the type or other specifics of the entity instances indicated by the representative objects to the user of the entity graph 600 by means of a visual coding. It may for example be possible to indicate the representative objects in different colours, shapes, line thicknesses, line types, shadings or other graphical effects. Further, it may be possible to visualise the representative objects with animation effects. It should be obvious to the skilled person that there is a multitude of different possible embodiments for the illustration of the representative objects the design of which may be based on external requirements.

Referring to the example of FIG. 4a an entity instance 51 of a higher level entity type may include an entity instance 52 of lower entity type level, for example a computer 51 having an IP address on which a program 52 is executed. The entity instance 52, for example the program 52, may include different entity instances 53a, 53b, 53c and 54 of even lower level entity type, for example different source files 53a, 53b, 53c and 54. The entity instances 53a, 53b and 53c may for example be connected by entity relations which are shown in FIG. 4a by connecting lines 57. For example the source files 53a, 53b, 53c may be interrelated by function calls. The entity instances 54, 55a, 55b and 56 may be arranged according to entity relations extracted from event data and entity types and be connected by connecting lines as shown. For example the entity graph 600 may be generated by analysing a log file.

It should be obvious that the visual appearance of the entity graph 600 is merely exemplary and that there is a multitude of different modes of graphical representations in order to visualise the entity instances and the entity relations.

According to the present disclosure it is further possible to generate event graphs from event data. Two exemplary possibilities for event graphs are schematically illustrated in FIGS. 4b and 4c.

FIG. 4b shows an event graph 400 illustrating events 21 according to their chronological sequence on a time line t. On the basis of the temporal proximity of the single events 21 event groups or event clusters 43a, 43b, 43c, 43d and 43e may be generated which each may comprise a different amount of events 21. The event clusters 43a, 43b, 43c, 43d and 43e themselves may be grouped up in higher level event clusters 44a and 44b in hierarchical order. The event clusters 44a and 44b may themselves be associated with an event cluster 45. In this exemplary visualisation arrows and connecting lines may indicate an association of neighbouring hierarchy levels in a cluster.

FIG. 4c shows another example for an event graph 500 in which for example method calls are associated with calling relations of hierarchically built methods 46, 47a, 47b, 48 according to their chronological order. For example, a method 46 is called at a calling point 46a. A method 47b depending on the method 46 is called for example at a calling point 47c. After a certain time span the method 47b is exited at a point in time 47d. The higher level method 46 is exited at a point in time 46b.

For the generation of event and/or entity graphs further boundary conditions and rule sets may be utilized. For example statistical methods may be used in order to detect a statistical correlation between different entity instances. To that end, entities which are often involved in the same event or in chronologically proximate events may be classified in a common graph node or connected with a connecting line. Entity instances which have the same or similar names may be grouped up and visualised in a common graph node.

Moreover, statistical information may be used, for example static entity trees from a conventional source code analysis or from documentations about architecture. These static entity trees may be accounted for in the generation of entity graphs by means of an entity comparison.

When generating entity and/or event graphs methods for reducing the complexity of the graphs may be used. For example, the number of hierarchy levels to be visualised or the total amount of events and/or entity instances to be visualised may be limited. It may be possible to only take into account those entity instances and entity relations the events of which they have been extracted have not elapsed a predefined time span ago. By doing so a windowing function may be constructed which only takes into account events temporarily when generating graphs. It may also be possible to perform a temporal zooming when generating the entity graph so that for a lot of changes in the entity graph the flow of changes may become more apparent to the viewer by more slowly illustrating the changes.

FIG. 5 shows a schematical illustration of a system 3 for visualising of a system model. The system 3 includes a detection interface 4 which is configured to receive data of a plurality of events which take place in a target system. Different detection devices 8a, 8b, 8c and 8d may be employed, which devices may be able to input event data in suitable format via the detection interface 4 into the system 3. The detection devices 8a, 8b, 8c and 8d may for example comprise instrumentalisation sections selectively included into a source code, which sections may be able to perform source code analysis and thereby generate event logs. The detection devices 8a, 8b, 8c and 8d may for example also comprise log file analyser, source code analyser, debugging tools, system call interceptors, network sniffers and similar devices which are configured to log event data.

An extraction device 5 is configured to extract entity instances of the target system involved in the events from the received data and to associate the entity instances to entity types of an entity type model of the target system stored in a configuration device 5a, which may for example be a database, a configuration file, a configuration memory, firmware, a volatile memory device or any other similar apparatus. The extraction device 5 is further configured to extract entity relations of the entity instances involved in the events from the received data.

A generating device 6 is configured to generate an entity graph by geometrically arranging of representative objects for the entity instances dependent on the entity relations on the basis of predetermined selection criteria for the entity types to be indicated by the graphs. The generating device 6 may further be configured to access to rendering components 6a, 6b, 6c, for example a WPF renderer, an SWT renderer or a web renderer all of which are able to illustrate graphs in a certain illustration technology, for example in WPF or websites. A user of the system 3 may submit selection criteria to the generating device 6 in order to adapt the visualisation of the graphs according to his needs.

An illustration device 7 is configured to show the entity graph generated by the generating device 6 graphically. The illustration device 7 may for example be a computer screen, a projection device or a similar illustrating apparatus.

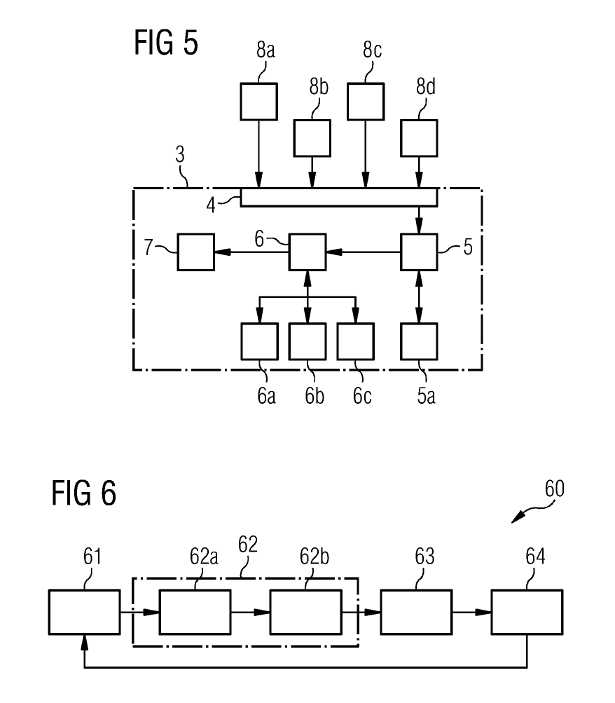

FIG. 6 shows a method 60 for visualising of a system model of a target system, in particular a method 60 which may be performed by the system 3 shown in FIG. 5. In a first step 61 detecting a plurality of events which take place in the target system is performed. In a second step 62 a partial step 62a involves extracting of entity instances involved in the detected events in the target system and associating the extracted entity instances with entity types of an entity model of the target system. In a partial step 62b extracting of entity relations of the entity instances involved in the detected events is performed. In a third step 63 generating an entity graph by geometrically arranging representative objects for the entity instances according to the entity relations dependent on predetermined selection criteria for the entity types to be indicated by the entity graph. In a step 64 the generated graphs may be illustrated using an illustration device. The steps 61 to 64 may be iterated in real time or near real time in order to provide for a quick and prompt visualisation of the target system for a user.

The disclosure pertains to a method for visualising a system model of a target system, the method comprising the steps of detecting a plurality of events which take place in the target system, extracting entity instances involved in the detected events in the target system and associating the extracted entity instances with entity types of an entity model of the target system, extracting entity relations of the entity instances involved in the detected events, and generating an entity graph by geometrically arranging representative objects for the entity instances according to the entity relations dependent on predetermined selection criteria for the entity types to be indicated by the entity graph.

What is claimed is:

1. Method for visualising a system model of a target system, comprising: detecting a plurality of events that take place in the target system;
extracting entity instances involved in the detected events in the target system and associating the extracted entity instances with entity types of an entity model of the target system;
extracting entity relations of the entity instances involved in the detected events; and
generating an entity graph by geometrically arranging representative objects for the entity instances according to the entity relations based on predetermined selection criteria for the entity types to be indicated by the entity graph.

2. Method of claim 1, further comprising:
detecting a further event taking place in the target system;
extracting entity instances involved in the further event and further entity relations; and
updating the entity graph by including further representative objects for the further entity instances or deleting representative objects, and changing the representative objects or the geometrical arrangement of the representative objects based on the further entity relations.

3. Method of claim 1, further comprising generating an event graph by geometrically arranging representative objects for the detected based on the chronological order of the detected events.

4. Method of claim 1, further comprising illustrating the entity graph on an illustration device during the detecting of further events.

5. Method of claim 4, further comprising:
updating the selection criteria; and
updating the entity graph based on the updated selection criteria.

6. Method of claim 1, wherein the selection criteria comprise at least one of a frequency of occurrence of the entity instances, an ending point of the detected events, a frequency of occurrence of the entity relations, and a type of entity of the entity instances.

7. Method of claim 1, wherein the geometrical arrangement comprises at least one of a tree structure, a nested object structure, a concentric sector structure, and a UML diagram structure.

8. System for visualising a system model of a target system, the system comprising:
a detection interface configured to receive data of a plurality of events taking place in the target system;
an extraction device configured to extract entity instances of the target system involved in the events from the received data and to associate the entity instances to entity types of an entity model of the target system and configured to extract entity relations of the entity instances involved in the events from the received data;
a generating device configured to generate an entity graph by geometrically arranging representative objects for the entity instances based on the entity relations on the basis of predetermined selection criteria for the entity types to be indicated by the entity graph; and
an illustration device configured to graphically illustrate the generated entity graph.

9. System of claim 8, wherein the system is configured to receive data of further events that take place in the target system in real time,
wherein the extraction device is configured to extract further entity instances involved in the further events and further entity relations from the further data,
wherein the generating device is configured to update the entity graph by incorporating further representative objects for the further entity instances or deleting representative objects, and changing the representative objects or the geometrical arrangement of the representative objects based on the further entity relations, and
wherein the illustration device is configured to update the graphical illustration of the entity graph in real time.

10. System of claim 8, wherein the generating device is further configured to generate an entity graph by geometrically arranging representative objects for the events based on the chronological order of the events.

11. System of claim 8, wherein the detection interface is configured to receive data of events taking place on a plurality of independent interacting system components of a distributed system, and
wherein the extraction device is further configured to extract entity relations between entity instances of different system components from the data.

12. System of claim 8, wherein the selection criteria comprise at least one of a frequency of occurrence of the entity instances, an ending point of the detected events, a frequency of occurrence of the entity relations, and a type of entity of the entity instances.

13. System of claim 8, wherein the geometrical arrangement comprises at least one of a tree structure, a nested object structure, a concentric sector structure, and a UML diagram structure.

14. Distributed system, comprising:
a plurality of independent interacting system components, each comprising one or more entities and on which events involving the entities take place;
at least one detection device configured to detect data of events taking place on the system components; and
a system for visualising a system model of the distributed system, the system comprising:
a detection interface configured to receive the data detected by the detection device of the plurality of events taking place on the system components;
an extraction device configured to extract entity instances of the system components involved in the events from the received data and to associate the entity instances to entity types of an entity model and configured to extract entity relations of the entity instances involved in the events from the received data;
a generating device configured to generate an entity graph by geometrically arranging representative objects for the entity instances based on the entity relations on the basis of predetermined selection criteria for the entity types to be indicated by the entity graph; and
an illustration device configured to graphically illustrate the generated entity graph.
